(19) United States
(12) Patent Application Publication
(10) Pub. No.: US 2025/0184687 A1
(43) Pub. Date: Jun. 5, 2025

(54) MICRO-LOCATION DEPENDENT USER-SUBSCRIBER EXPERIENCE SUPPORTED BY A TELECOMMUNICATIONS NETWORK

(71) Applicant: T-Mobile USA, Inc., Bellevue, WA (US)

(72) Inventors: Joohyung Kim, Seattle, WA (US); Jim Joojin Song, Atlanta, GA (US); Eugene Shulga, Bothell, WA (US); Chen An Wang, Bellevue, WA (US)

(21) Appl. No.: 18/529,476

(22) Filed: Dec. 5, 2023

Related U.S. Application Data
(60) Provisional application No. 63/606,185, filed on Dec. 5, 2023.

(51) Int. Cl. H04W 4/021; G06T 7/536

(52) U.S. Cl. CPC H04W 4/021; G06T 7/536

(57) ABSTRACT

A system can personalize a user-subscriber experience for a subscriber of a telecommunications network. The system can detect presence of a wireless mobile device in the indoor environment, proximate to a smart device (e.g., a smartphone offered for sale). The system can retrieve subscriber data based on a unique identifier of the subscriber. The subscriber data is indicative of activity of the subscriber on the telecommunications network. The system can input the subscriber data into a large language model (LLM) that outputs a personalized offer agreement to present on the wireless mobile device or the smart device. The personalized offer agreement is tailored for the subscriber and the smart device. In one example, the offer agreement includes contextual pricing for the smart device based on the subscriber data.

### CROSS-REFERENCE TO RELATED APPLICATIONS

This application claims the benefit of U.S. Patent Application No. 63/606,185, filed on Dec. 5, 2023, entitled CHECK-IN USER EXPERIENCE SUPPORTED BY A TELECOMMUNICATIONS NETWORK, which is hereby incorporated by reference in its entirety.

### BACKGROUND

Location-based services (LBS) refer to services that use geographic data and information to provide services or information to users. LBS can be used in a variety of contexts, such as health, indoor object search, entertainment, work, and personal life. Commonly used examples of location-based services include navigation software, social networking services, location-based advertising, and tracking systems. LBS can also include mobile commerce when taking the form of coupons or advertising directed at customers based on their current location. LBS also includes personalized weather services and even location-based games.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a system that creates micro-location dependent user-subscriber experiences supported by a telecommunications network.

FIG. 4 is a block diagram that illustrates an indoor environment configured to personalize experiences of a user-subscriber of a telecommunications network.

FIG. 5 is a flowchart that illustrates a process for generating personalized content for a user-subscriber of a telecommunications network in a check-in environment.

FIG. 6 is a flowchart that illustrates a process for personalizing an experience of a user-subscriber of a telecommunications network in a retail environment.

FIG. 7 is a flowchart that illustrates a process for personalizing interactions of a service agent to assist a user-subscriber in a service environment.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technologies relate to refining consumer interactions and experiences in a retail environment based on a precise location in the environment and providing tailored interactions using generative artificial intelligence (also referred to as “genAI,” “GAI,” or “generative AI”) to increase user interaction and provide better service. This is challenging because contextually aware interactions are difficult to construct in a manner that minimizes annoyance to the user (e.g., repeated prompts to a user walking through a retail space) while providing functional information. Additionally, it is challenging to predict the appropriate information to present at the optimal time to maximize the chance of user interaction. The disclosed model is trained to overcome these challenges by aggregating user data and using generative artificial intelligence to customize an experience for the user.

The disclosed invention solves the technical problem of how to customize the user experience when entering a physical location using micro-location and generative artificial intelligence. The solution to this technical problem is to use either an active or passive trigger (e.g., a quick response (QR) code or beacon, respectively) to generate a unique page based on historical user interactions to present to the user upon entering a physical location. Solving this technical problem provides the practical benefit of tailoring a user's initial engagement at a physical location to present not only the forms and welcome message—portions of which are generated through GAI—but also the expected wait time based on the traffic and labor status.

Another problem that the disclosed invention solves is the technical problem of how to customize the user experience when observing display devices using micro-location and GAI. The solution to this technical problem is to use the display devices as beacons to present custom data to users within the same micro-location (e.g., if the subscriber is near a new handset, the system can access their subscriber data and present relevant discounts regarding the handset the user is interested in purchasing). Solving this technical problem provides the practical benefit of tailoring a user's shopping experience based on previous user interactions and demonstrated, location-based interest.

Additionally, the disclosed invention solves the technical problem of how to generate personalized user experiences using micro-location and generative artificial intelligence. The solution to this technical problem is to use a combination of active and passive structured data (e.g., data provided by the user and data gathered from a wireless mobile device, respectively) to generate a prompt and use the prompt to generate content for consumption by the user. Solving this technical problem provides the practical benefit of improving customer satisfaction and efficiency and allows customer service associates to anticipate a customer's needs.

GAI is an artificial intelligence at includes one or more models that can learn from existing information to generate new information. It can produce a variety of novel content, such as images, video, music, speech, text, software code, and product designs. The information provided to the system can include text, previous interactions with various systems, or other media associated with the user. Using data associated with the user as input, GAI can generate situationally appropriate content for customer or service consumption.

Within the context of this invention, GAI can be used to generate welcome messages to a user predicated on previous user interactions with the company (e.g., a chat with customer service prior to entering a physical retail location). Furthermore, generative AI can be used to generate a script or outline of potential issues to help the user in the retail location (e.g., a user viewed a new handset on an application prior to entering a physical retail location, or a user was chatting with a representative about an issue).

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

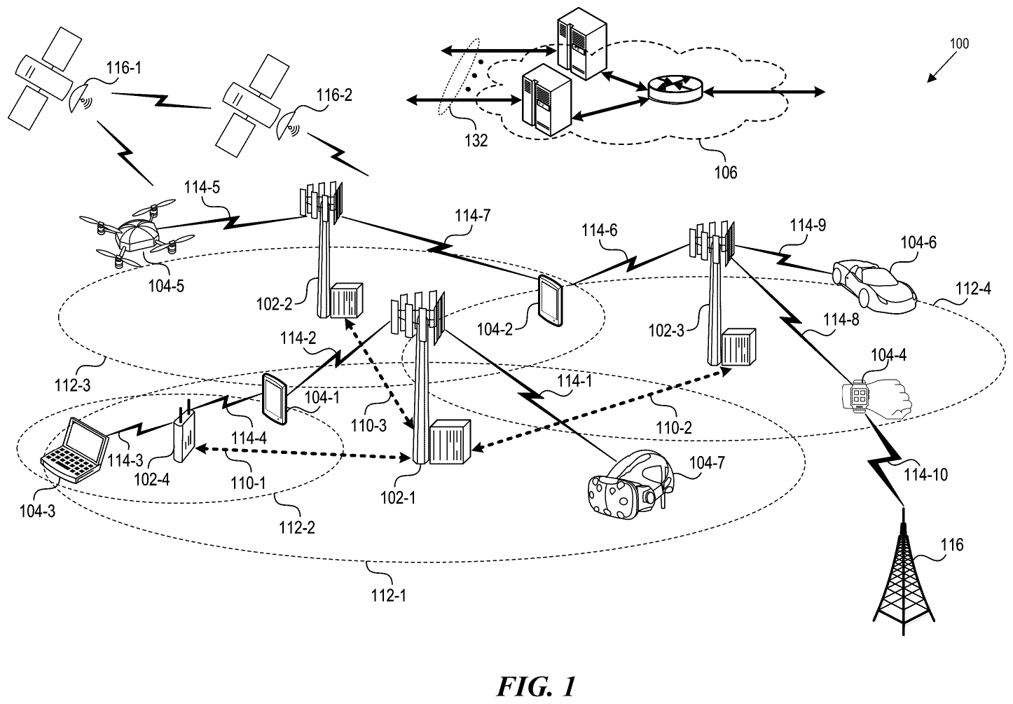

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

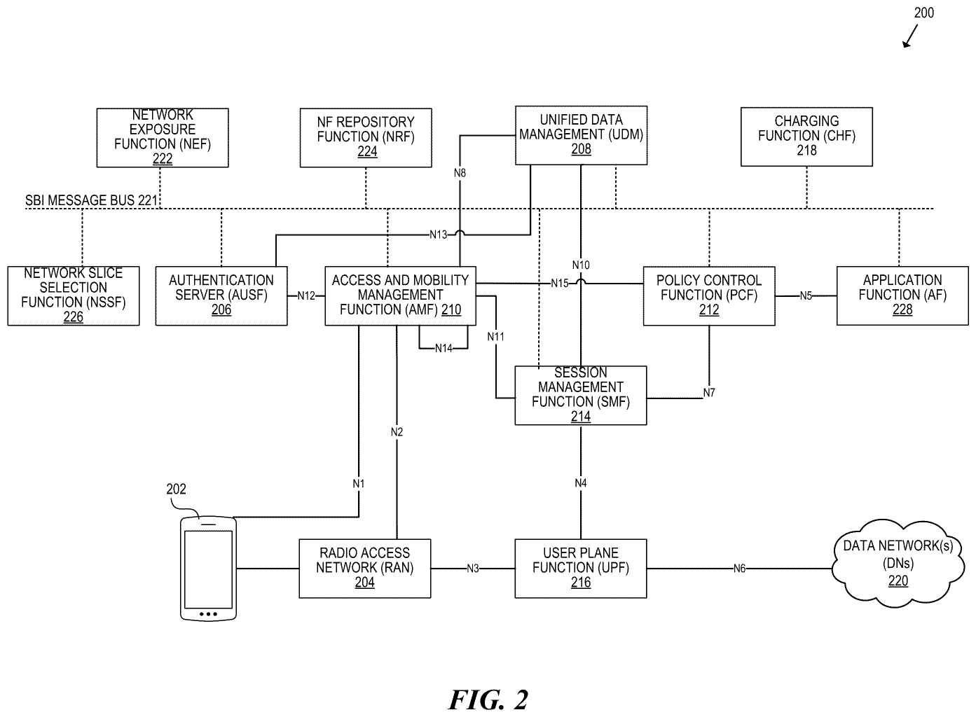

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Micro-Location Dependent User-Subscriber Experiences

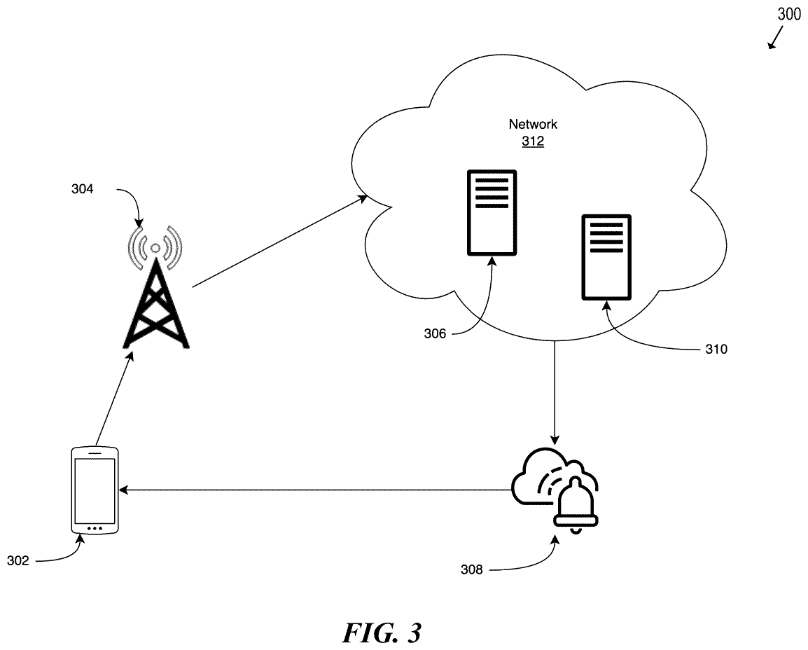

FIG. 3 is a block diagram that illustrates a system 300 that creates micro-location dependent user-subscriber experiences supported by a telecommunications network. The system 300 includes a wireless mobile device 302 that is communicatively coupled through network access node 304 of a telecommunications network to a cloud network 312. The network 312 houses servers including server 306 and server 310 that support the functions of the disclosed technology. Lastly, an LBS 308 is configured to personalize the experience of a subscriber of the telecommunications network.

The wireless mobile device 302 can include any electronic device that is subscribed to the telecommunications network. Examples of wireless mobile devices includes smartphones, tablets, smart watches, head-mounted display devices, etc. A network operator operates the telecommunications network to provide services to subscribers. A user of the wireless mobile device 302 is not necessarily the subscriber. For example, the user of the wireless mobile device 302 can include a relative, acquaintance, or employee of the subscriber. The disclosed technology is configured to customize or personalize an experience for a subscriber because subscriber data is used to train the models that generate the output for personalization. Moreover, inputs to the model can include subscriber data such as an activity last performed by the subscriber to engage a service agent of the network operator to troubleshoot the wireless mobile device 302. The term “user-subscriber” is thus used herein to refer to a subscriber using the wireless mobile device 302.

The servers 306 and server 310 are representative of compute and storage devices and software that perform functions of the disclosed technology. Examples include hardware and software that support GAI models, store subscriber data and training data, and outputs including generated content that is sent to the LBS 308. The LBS 308 is configured to assist the user-subscriber of the wireless mobile device 302 by determining a micro-location and to feed personalized content to the wireless device 302 that is received for a generative model located at the network 312.

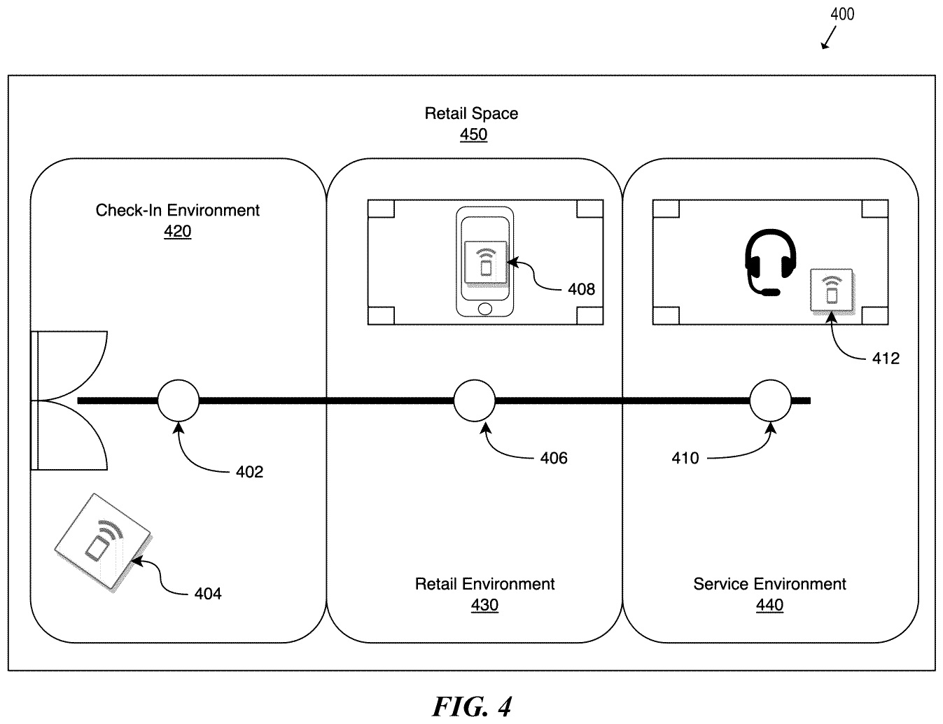

FIG. 4 is a block diagram that illustrates an indoor environment 400 configured to personalize experiences of a user-subscriber of a telecommunications network. The example shown includes a retail space 450 solely for the purposes of illustrating an embodiment of the technology. The retail space 450 is an indoor environment that offers products and services to users. The disclosed technology can also be deployed in an outdoor environment such as an outdoor shopping center or outdoor sports venue.

An example of the retail space 450 is a store operated for a network operator of a telecommunications network to sell smart devices, accessories, and services. As illustrated, the retail space 450 has three portions at different locations where the user travels through the retail space 450. The first portion includes a check-in environment 420 that the user-subscriber enters at location 402 of the retail space 450. The check-in environment 420 optionally includes a display device 404 for the user to check-in. An example of the display device includes a kiosk device or other stationary device at the front of the retail store. In another example, the display device 404 is a wireless mobile device operated by an agent of the retail space 450.

The system can detect the user-subscriber at the location 402 in the check-in environment 420 based on the location of its wireless mobile device and/or the user-subscriber interacting with the display device 404. In one example, the display device 404 displays a QR code that the user-subscriber can scan with its wireless mobile device. The QR code can include a link to a site of the network operator that prompts the user for a unique identifier such as a phone number. Alternatively or additionally, the wireless device can receive beacon signals broadcast from one or more beacons located at the check-in environment 420. The beacon signals can indicate location information that is used by the wireless mobile device to detect a micro-location of the user-subscriber. Alternatively or additionally, the signal strength of beacon signals can be used to estimate the location of the wireless mobile device. The wireless mobile device can transmit a signal to the display device 404 using a short-range radio frequency (RF) protocol such as Bluetooth or Wi-Fi. Alternatively or additionally, the wireless mobile device can transmit the location information over the telecommunications network to the system. The wireless mobile device and/or display device 404 can present custom content that is personalized for the user-subscriber. The custom content is generated as described elsewhere in this disclosure to present, for example, a custom greeting based on the user-subscriber's prior activities on the telecommunications network.

The second portion includes the retail environment 430 that the user-subscriber proceeds to at location 406 of the retail space 450. The retail environment 430 includes a smart device 408 that is offered in the retail space 450 to customers including the user-subscriber. An example of the smart device 408 includes any communications device that can communicate over the telecommunications network and/or over short-range RF networks. The system can detect the user-subscriber at the location 406 in the retail environment 430 in the same way as described earlier. Alternatively or additionally, the smart device 408 can be configured to operate as a beacon device that is used to detect the presence of the wireless mobile device and/or proximity of the wireless mobile device from the smart device 408. The wireless mobile device and/or smart device 408 can present custom content that is personalized for the user-subscriber. The custom content is generated as described elsewhere in this disclosure to present, for example, an offer agreement including contextual pricing that is generated based on the user-subscriber's prior activities on the telecommunications network.

The third portion includes the service environment 440 that the user-subscriber proceeds to at location 410 of the retail space 450. The service environment 440 includes a service device 412 of a service agent of the retail space 450. The service agent can efficiently assist the user-subscriber with personalized guidance. An example of the service device 412 includes any communications device that can communicate over the telecommunications network and/or over short-range RF networks. The system can detect the user-subscriber at the location 410 in the service environment 440 in the same way as described earlier. Alternatively or additionally, the service device 412 can be configured to operate as a beacon device that is used to detect the presence of the wireless mobile device and/or proximity of the wireless mobile device in the service environment 440. The wireless mobile device and/or service device 412 can present custom content that is personalized for the user-subscriber. The custom content is generated as described elsewhere in this disclosure to present, for example, a guide that helps a service agent assist the user-subscriber based on the user-subscriber's prior activities on the telecommunications network. For example, prior activities can include that the user-subscriber visited the same retail space 450 and/or contacted service agents of the network operator about related issues with the wireless mobile device and/or a service of the telecommunications network.

Personalized Content Generation from Subscriber Data

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a transformer, can be used as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

A transformer can include an encoder (which can comprise one or more encoder layers/blocks connected in series) and a decoder (which can comprise one or more decoder layers/blocks connected in series). Generally, the encoder and the decoder each include neural network layers, at least one of which can be a self-attention layer. The parameters of the neural network layers can be referred to as the parameters of the language model.

The transformer can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer is trained to perform certain functions on other input formats than natural language input. For example, the input can include objects, images, audio content, or video content, or a combination thereof.

The transformer can be trained on a text corpus that is labeled (e.g., annotated to indicate verbs, nouns, etc.) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 2 illustrates an example of how the transformer can process textual input data. Input to a language model (whether transformer-based or otherwise) typically is in the form of natural language that can be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In one example, a short sequence of tokens corresponds to the input text to the transformer. Tokenization of the text sequence into the tokens can be performed by some pre-processing tokenization module such as, for example, a byte-pair encoding tokenizer (the “pre” referring to the tokenization occurring prior to the processing of the tokenized input by the LLM). In general, the token sequence that is inputted to the transformer can be of any length up to a maximum length defined based on the dimensions of the transformer. Each token in the token sequence is converted into an embedding vector (also referred to simply as an embedding). An embedding is a learned numerical representation (such as, e.g., a vector) of a token that captures some semantic meaning of the text segment represented by the token. The embedding represents the text segment corresponding to the token in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token to an embedding. For example, another trained ML model can be used to convert the token into an embedding. In particular, another trained ML model can be used to convert the token into an embedding in a way that encodes additional information into the embedding (e.g., a trained ML model can encode positional information about the position of the token in the text sequence into the embedding). In some examples, the numerical value of the token can be used to look up the corresponding embedding in an embedding matrix (which can be learned during training of the transformer).

The generated embeddings are input into the encoder. The encoder serves to encode the embeddings into feature vectors that represent the latent features of the embeddings. The encoder can encode positional information (i.e., information about the sequence of the input) in the feature vectors. The feature vectors can have very high dimensionality (e.g., on the order of thousands or tens of thousands), with each element in a feature vector corresponding to a respective feature. The numerical weight of each element in a feature vector represents the importance of the corresponding feature. The space of all possible feature vectors that can be generated by the encoder can be referred to as the latent space or feature space.

Conceptually, the decoder is designed to map the features represented by the feature vectors into meaningful output, which can depend on the task that was assigned to the transformer. For example, if the transformer is used for a translation task, the decoder can map the feature vectors into text output in a target language different from the language of the original tokens. Generally, in a generative language model, the decoder serves to decode the feature vectors into a sequence of tokens. The decoder can generate output tokens one by one. Each output token can be fed back as input to the decoder in order to generate the next output token. By feeding back the generated output and applying self-attention, the decoder is able to generate a sequence of output tokens that has sequential meaning (e.g., the resulting output text sequence is understandable as a sentence and obeys grammatical rules). The decoder can generate output tokens until a special [EOT] token (indicating the end of the text) is generated. The resulting sequence of output tokens can then be converted to a text sequence in post-processing. For example, each output token can be an integer number that corresponds to a vocabulary index. By looking up the text segment using the vocabulary index, the text segment corresponding to each output token can be retrieved, the text segments can be concatenated together, and the final output text sequence can be obtained.

In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model such as ChatGPT or GPT-3 via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

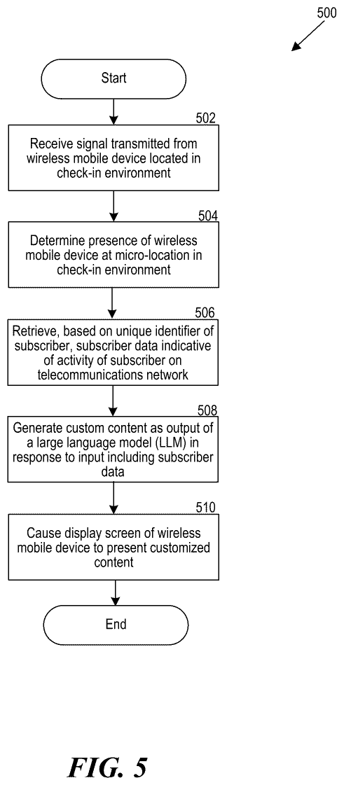

FIG. 5 is a flowchart that illustrates a process 500 for generating personalized content for a user-subscriber of a telecommunications network in a check-in environment. The process 500 can be performed by a system of a network operator of the telecommunications network. More specifically, one or more non-transitory, computer-readable storage media storing instructions recorded thereon that, when executed by at least one data processor of a system of a telecommunications network, cause the system to perform the process 500.

At 502, the system can receive a signal transmitted from a wireless mobile device located in a check-in environment. The wireless mobile device is associated with a subscriber of the telecommunications network. In one example, the signal includes a unique identifier for the subscriber (e.g., account number, telephone number) or unique identifier of the wireless mobile device (e.g., IMEI (International Mobile Equipment Identity)) and an indication of being in the check-in environment (e.g., store identifier). The location of the wireless mobile device can be determined based on, for example, a short-range signal that is broadcast from a beacon device located in the check-in environment.

In one example, the system can receive a subscriber identification number from the wireless mobile device. In one example, a request can be generated in response to an interaction at a stationary device located in the check-in environment. In response to the request, the system can receive the subscriber identification number, where the unique identifier can be based on or equal to the subscriber identification number such as a phone number or account number. For example, a kiosk device near the door of a store for mobile devices and services can present a graphical element such as a QR code (e.g., two-dimensional (2D) code) on its display. The user of a smartphone can scan the QR code, which can send a notification to the system about the presence of the smartphone and either automatically retrieve a unique identifier for the subscriber-user or present an interface on the smartphone to request that the user input the unique identifier such as an account number or Social Security number.

At 504, the system can determine, based on the signal, a physical presence of the wireless mobile device at a micro-location in the check-in environment. For example, the system can determine that the wireless mobile device has entered a retail store and needs to be checked in. In one example, the system can determine the physical presence of the wireless mobile device at a micro-location based on one or more beacon signals that are received by the wireless mobile device. For example, the wireless mobile device can obtain a combination of identifiers of beacons and relay that information to the system, which can determine the micro-location based on the identifiers. In another example, the micro-location can be determined at the wireless mobile device and then communicated to the system along with or separate from the unique identifier for the subscriber and/or the subscriber device.

In another example, the system can determine the physical presence of the wireless mobile device at a micro-location in the check-in environment based on, for example, a QR code that is scanned using a camera of the wireless mobile device. The QR code can be displayed on a kiosk or other device of the network operator or could simply be posted or posted on as an image on a flat surface. The wireless mobile device can be triggered to send a notification to the system in response to scanning the graphical element. For example, a QR code can include a link that, when executed on the wireless mobile device, presents an interface that requests the unique identifier for the subscriber. The unique identifier, along with an identifier for the location of the QR code, can be communicated to system to indicate the location of the wireless mobile device.

In one example, a triggering event is detected when a value for a received signal strength indicator (RSSI) of a beacon signal satisfies or exceeds a threshold value. In another example, the triggering event is detected based on an interaction of the wireless mobile device with the graphical element on a display device (e.g., kiosk). In another example, the triggering event is determined as an estimate of a distance to the wireless mobile device from the kiosk device based on an image of the wireless mobile device captured by a camera of the kiosk device. That is, the estimate can be based on the size of the wireless mobile device in the image. The system can determine that the estimate satisfies or exceeds a threshold distance. The triggering event is detected when the estimated distance meets or exceeds a threshold distance. In yet another example, the triggering event is detected when a kiosk device scans a spatial area proximate to the kiosk device at regular intervals using a visualization sensor. The visualization sensor is integrated in the kiosk device and the presence of the wireless mobile device is detected in the scan of the spatial area. The triggering event is detected based on the detected presence of the wireless mobile device in the scan of the spatial area.

At 506, the system can retrieve, based on the unique identifier, subscriber data indicative of activity of the subscriber on the telecommunications network. In one example, the subscriber data can include activity data of subscribers on the telecommunications network. Examples includes transcriptions of voice or video calls communicated over the network, text-based messages communicated over the network, or browsing histories of subscribers of the telecommunications network. In another example, the subscriber data is retrieved from the UDM or other nodes of the telecommunication network.

At 508, the system can generate custom content as output of a LLM in response to input including the subscriber data. In one example, the LLM is trained based on activity data of subscribers on the telecommunications network. Examples of the activity data include any of transcriptions of voice or video calls communicated over the telecommunications network, text-based messages communicated over the telecommunications network, or browsing histories of subscribers of the telecommunications network. In one example, inputs from the user-subscriber to the stationary device are input to the LLM. That is, user inputs to a kiosk device can be input to the LLM model. The custom content can be customized for the particular subscriber and the particular check-in environment and in response to particular inputs by the user-subscriber at the check-in environment. As such, the content can be tailored for the user, and further tailored based on the check-in environment in which the wireless mobile device is located.

At 510, the system can cause a display screen of the wireless mobile device to present the customized content on a user interface. The customized content can include a custom control (e.g., widget) presented on the user interface. The custom control enables an interaction at the wireless mobile device with an LBS of the check-in environment. In one example, the output from the LLM is used to generate a list of options that are selectable at the user interface of the wireless mobile device based on prior interactions between the subscriber and agents of the telecommunications network. The list of options can be presented on the user interface on the display of the wireless mobile device.

In one example, the system can generate custom content by computing a threshold time of the wireless mobile device relative to a reference time of subscribers at the check-in environment. The threshold time is calculated based on user traffic data and customer experience data of subscribers to the telecommunications network. The threshold time can be determined as an entry time when the wireless mobile device entered the check-in environment or determined as a wait time based on a difference between the entry time and a current time of the wireless mobile device in the check-in environment.

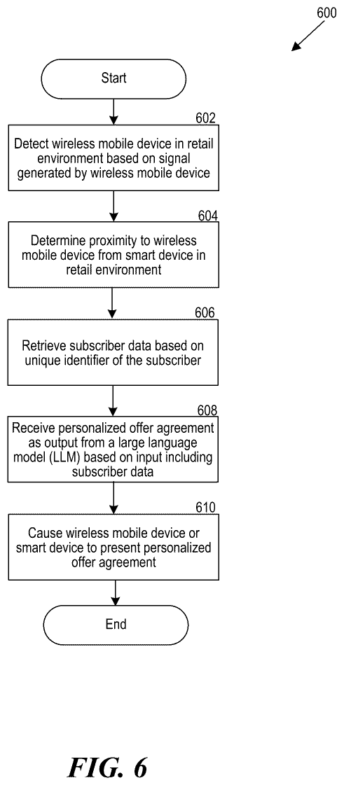

FIG. 6 is a flowchart that illustrates a process 600 for personalizing an experience of a user-subscriber of a telecommunications network in a retail environment. The process 600 can be performed by a system of a network operator of the telecommunications network. More specifically, one or more non-transitory, computer-readable storage media storing instructions recorded thereon that, when executed by at least one data processor of a system of a telecommunications network, cause the system to perform the process 600.

The retail environment can be owned or administered by a network operator of the telecommunications network. The retail environment can include multiple smart devices associated with respective offer agreements. The system can cause the wireless mobile device or the smart devices to present respective offer agreements that are personalized for the subscriber and respective smart devices.

At 602, the system can detect a wireless mobile device in the retail environment based on a signal generated by the wireless mobile device. The wireless mobile device is associated with a subscriber to a telecommunications network. In one example, the signal is generated in response to a beacon signal being received by the wireless mobile device. The signal can include a unique identifier of the subscriber.

In one example, the system can cause one or more beacon devices to transmit beacon signals at regular intervals. The micro-location can be determined at the wireless mobile device based on the beacon signals received from the multiple beacon devices. In another example, the smart device associated with the offer agreement is configured as a beacon device to transmit a beacon signal, which can be used by the wireless mobile device to determine a micro-location proximate to the smart device.

In another example, the micro-location of the wireless mobile device is determined based on an RSSI of the signal. The signal can be transmitted using a Bluetooth protocol or a Wi-Fi protocol. In another example, the system can detect a triggering event on the smart device. The triggering event can indicate that the wireless mobile device is proximate to the smart device. In one example, the smart device is a smartphone that is configured as a beacon device to transmit beacon signals at a regular interval. The triggering event can include an indication that the wireless mobile device received the beacon signal.

At 604, the system can determine a proximity to the wireless mobile device from a smart device in the retail environment. The smart device is associated with an offer agreement for the retail environment. For example, a smartphone or smartwatch can be associated with an offer for a customer to purchase the product for a particular price and associated service for a monthly cost. The system can determine the proximity to the wireless mobile device from the smart device by, for example, estimating a distance to the wireless mobile device from the smart device based on an image of the wireless mobile device captured by a camera of the smart device. The estimate is based on the size of the wireless mobile device in the image. The wireless mobile device is determined to be proximate to the smart device when the estimate meets or exceeds a threshold distance.

At 606, the system can retrieve subscriber data based on the unique identifier of the subscriber. The subscriber data indicates activity data of the subscriber on the telecommunications network. In one example, the activity data of the subscribers can include transcriptions of voice or video calls communicated over the telecommunications network, text-based messages communicated over the telecommunications network, and/or browsing histories of subscribers of the telecommunications network. In another example, the subscriber data is retrieved from a UDM or other nodes of the telecommunication network.

At 608, the system can receive a personalized offer agreement as output from an LLM based on input including the subscriber data. The LLM is trained based on subscriber activity data of subscribers on the telecommunications network. The system can input the unique identifier and information about the smart device into the LLM that is trained based on activity data of subscribers to the telecommunications network. The LLM can output proximity-based information including an offer agreement that is personalized for the subscriber and the smart device.

At 610, the system can cause the wireless mobile device or the smart device to present the personalized offer agreement, which is personalized for the subscriber and the smart device. In one example, the system can enable a user to interact with the personalized offer agreement by selecting a button on the user interface to request additional information about the device accessible by the subscriber. The personalized offer agreement can include contextual pricing for the smart device. In one example, the system can cause display of personalized information on the wireless mobile device. The system can receive input at the wireless mobile device including an interaction with the personalized information to accept the offer agreement.

In another example, the system can cause display of personalized information on the smart device associated with the offer agreement. In response to the personalized information, the system can configure the smart device to receive input to accept the offer agreement. In another example, the system can cause display of personalized information on a kiosk device proximate to the smart device, where the personalized information is generated by the LLM. In response to the personalized information, the system can configure the kiosk device to receive input to accept the offer agreement.

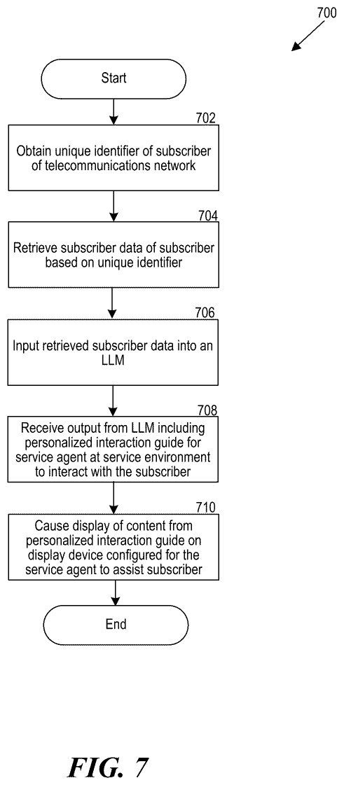

FIG. 7 is a flowchart that illustrates a process for personalizing interactions of a service agent to assist a user-subscriber in a service environment. The process 700 can be performed by a system of a network operator of the telecommunications network. More specifically, one or more non-transitory, computer-readable storage media storing instructions recorded thereon that, when executed by at least one data processor of a system of a telecommunications network, cause the system to perform the process 700.

At 702, the system can obtain a unique identifier of a subscriber of a telecommunications network. The system can detect presence of the user device at the indoor location, request the identifier from the user device, and in response to the request, receive the identifier from the user device. The subscriber is associated with a wireless mobile device located in a service environment, for example. For example, the system can receive a signal generated by the wireless mobile device in response to receiving a short-range beacon signal broadcast at the service environment. The signal includes an indication of a signal strength value for the short-range beacon signal. The short-range beacon signal is broadcast in accordance with a Wi-Fi or Bluetooth protocol. The system can determine that the signal strength value satisfies or exceeds a threshold value. The threshold value can indicate a micro-location of the wireless mobile device in the service environment. The system can transmit a request to the wireless mobile device for the unique identifier and, in response to the request, receive the unique identifier from the wireless mobile device.

In another example, the system can receive a signal generated by the wireless mobile device in response to receiving a short-range beacon signal broadcast at the service environment. The signal includes an indication of a micro-location of the wireless mobile device based on a signal strength value of the short-range beacon signal. The system can determine that the micro-location is proximate to the service agent in the service environment.

In another example, the system can detect, based on a near field communication (NFC), that the wireless mobile device is proximate to a service device associated with the service agent at the service environment. The NFC is between the wireless mobile device and the service device. The system can identify the unique identifier of subscriber of the wireless mobile device based on the NFC. In another example, the system can cause activation of a radio frequency identification (RFID) module integrated in the wireless mobile device. The system can identify the unique identifier of subscriber of the wireless mobile device upon entering a predefined zone of an RFID tag located in the service environment.

In one example, the system can cause activation of a service device in the service environment to present a 2D barcode (e.g., QR code) to the wireless mobile device. The 2D barcode codes a uniform resource locator (URL) to a webpage for the service administered by the operator of the telecommunications network. The system can cause the wireless mobile device to, upon scanning the 2D barcode, present a user interface including a request that prompts a user of the wireless device to present the unique identifier. In one example, the system can retrieve user data associated with a user device located in the retail environment. The user data is retrieved based on an identifier for the user device and is indicative of activity of the user device with a service.

At 704, the system can retrieve subscriber data of the subscriber based on the unique identifier. In one example, the subscriber data is indicative of historical interactions of the subscriber with a service administered by an operator of the telecommunications network. In another example, the subscriber data indicates activity data of the subscriber on the telecommunications network. In one example, the activity data of the subscribers can include transcriptions of voice or video calls communicated over the telecommunications network, text-based messages communicated over the telecommunications network, and/or browsing histories of subscribers of the telecommunications network. In another example, the subscriber data is retrieved from a UDM or other nodes of the telecommunication network.

At 706, the system can input the retrieved subscriber data into an LLM. In one example, the LLM is trained to generate a ranked list of subscriber insights about a particular subscriber in the service environment. The ranked list can be based on historical interactions between the particular subscriber and the service administered by the operator of the telecommunications network. In one example, the LLM is caused to generate a summary of a recent interaction between the subscriber and the service administered by the operator of the telecommunications network, generate an analysis of the recent interaction based on NLP and tone detection, and include the summary and the analysis of the recent interaction in the personalized interaction guide.

At 708, the system can receive, as output from the LLM, a personalized interaction guide including instructions for a service agent located at the service environment to interact with the subscriber. The service agent is an agent of the service administered by the operator of the telecommunications network. In one example, the system can input a subscriber insight for the subscriber into the LLM, retrieve a date and a time of a recent interaction associated with the subscriber insight, order multiple subscriber insights including the subscriber insight based on the date and the time, and receive, as output of the LLM, the ranked list of the multiple subscriber insights. In another example, the system can input a subscriber insight for the subscriber into the LLM, retrieve a date and a time of a recent interaction associated with the subscriber insight, order multiple subscriber insights including the subscriber insight based on the date and the time, and output the ranked list of the multiple subscriber insights. In another example, the system can input a subscriber insight for the subscriber into the LLM, retrieve a numerical value for a recent interaction associated with the subscriber insight, order multiple subscriber insights including the subscriber insight based on the numerical value, and receive, as output of the LLM, the ranked list of the multiple subscriber insights.

In one example, the system can generate the personalized interaction guide based on input of a subscriber insight for the subscriber into the LLM. The system can retrieve a tone prediction for a recent interaction associated with the subscriber insight, order multiple subscriber insights including the subscriber insight based on the tone prediction, and receive, as output of the LLM, the ranked list of the multiple subscriber insights.

At 710, the system can cause display of content from the personalized interaction guide on a display device configured for the service agent to assist the subscriber. In one example, the personalized interaction guide is modifiable at a service device in the service environment by the service agent of the service administered by the operator of the telecommunications network to update or correct information based on an in-person interaction between the subscriber and the service agent.

### Computer System

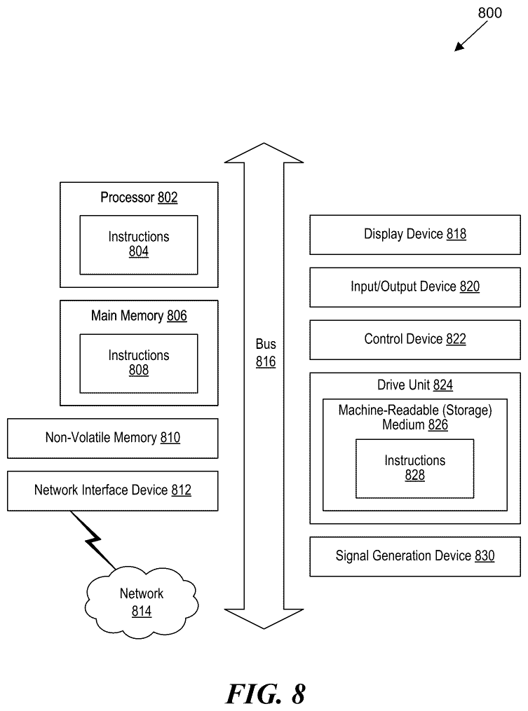

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system for personalizing a user-subscriber experience, the system comprising:
at least one hardware processor; and
at least one non-transitory memory storing instructions, which, when executed by the at least one hardware processor, cause the system to:
detect a wireless mobile device in an indoor environment based on a signal generated by the wireless mobile device,
wherein the wireless mobile device is associated with a subscriber to a telecommunications network,
wherein the signal is generated in response to a beacon signal being received by the wireless mobile device, and
wherein the signal includes a unique identifier of the subscriber;
determine a proximity to the wireless mobile device from a smart device in the indoor environment,
wherein the smart device is associated with an offer agreement for the indoor environment;
retrieve subscriber data based on the unique identifier of the subscriber,
wherein the subscriber data indicates activity data of the subscriber on the telecommunications network;
receive a personalized offer agreement as output from a large language model (LLM) based on input including the subscriber data,
wherein the LLM is trained based on subscriber activity data of subscribers on the telecommunications network; and
cause the wireless mobile device or the smart device to present the personalized offer agreement is personalized for the subscriber and the smart device.

2. The system of claim 1, wherein the activity data of the subscribers comprises any of:
transcriptions of voice or video calls communicated over the telecommunications network,
text-based messages communicated over the telecommunications network, or
browsing histories of subscribers of the telecommunications network.

3. The system of claim 1 further caused to:
enable a user to interact with the personalized offer agreement by selecting a button on a user interface presented on wireless mobile device or the smart device to request additional information about the device accessible by the subscriber,
wherein the personalized offer agreement includes contextual pricing for the smart device.

4. The system of claim 1 further caused to:
cause multiple beacon devices including the beacon device to transmit beacon signals at regular intervals; and
determine a micro-location of the wireless mobile device based on the beacon signals received from the multiple beacon devices,
wherein the proximity to the wireless mobile device from a smart device is determined based on the micro-location.

5. The system of claim 1 further caused to:
cause a beacon device to transmit the beacon signal at a regular interval; and
determine a micro-location of the wireless mobile device based on the beacon signal received from the beacon device,
wherein the proximity to the wireless mobile device from a smart device is determined based on the micro-location.

6. The system of claim 1 further caused to:
cause the smart device to transmit the beacon signal at a regular interval; and
determine a micro-location of the wireless mobile device based on the beacon signal received from the beacon device,
wherein the proximity to the wireless mobile device from a smart device is determined based on the micro-location.

7. The system of claim 1 further caused to:
determine a micro-location of the wireless mobile device based on a received signal strength indicator (RSSI) of the signal,
wherein the signal is transmitted using a Bluetooth protocol or a Wi-Fi protocol, and
wherein the proximity to the wireless mobile device from a smart device is determined based on the micro-location.

8. The system of claim 1, wherein the indoor environment includes multiple smart devices associated with respective offer agreements, and wherein the system is further caused to:
cause the wireless mobile device or the smart devices to present respective offer agreements that are personalized for the subscriber and respective smart devices.

9. The system of claim 1, wherein to determine the proximity to the wireless mobile device from the smart device comprises causing the system to:
estimate a distance to the wireless mobile device from the smart device based on an image of the wireless mobile device captured by a camera of the smart device,
wherein the estimate is based on a size of the wireless mobile device in the image, and
wherein the wireless mobile device is determined to be proximate to the smart device when the estimate satisfies or exceeds a threshold distance.

10. The system of claim 1 further caused to:
cause display of personalized information on the wireless mobile device, wherein the personalized information is generated by the LLM; and
receive input at the wireless mobile device including an interaction with the personalized information to accept the offer agreement.

11. The system of claim 1 further caused to:
cause display of personalized information on the smart device,
wherein the personalized information is generated by the LLM; and
in response to the personalized information, configure the smart device to receive input to accept the offer agreement.

12. The system of claim 1 further caused to:
cause display of personalized information on a kiosk device proximate to the smart device,
wherein the personalized information is generated by the LLM; and
in response to the personalized information, configure the kiosk device to receive input to accept the offer agreement.

13. A method for personalizing subscriber experience at a indoor environment, the method comprising:
detecting, using a triggering event at a smart device in the indoor environment, a wireless mobile device associated with a subscriber of a telecommunications network,
wherein the triggering event indicates that the wireless mobile device is proximate to the smart device;
receiving a unique identifier of the subscriber from the wireless mobile device;
inputting the unique identifier and information about the smart device to a large language model (LLM) that is trained based on activity data of subscribers to the telecommunications network;
receiving, as output from the LLM, proximity-based information including an offer agreement that is personalized for the subscriber and the smart device; and
causing the wireless mobile device, the smart device, or a kiosk proximate to the smart device to present the proximity-based information.

14. The method of claim 13, wherein detecting the wireless mobile device proximate to the smart device further comprises:
causing the smart device to transmit a beacon signal at a regular interval,
wherein the triggering event includes an indication that the wireless mobile device received the beacon signal.

15. The method of claim 13:
wherein smart device is a smart phone that is configured as a beacon device to transmit beacon signal at a regular interval, and
wherein the triggering event includes an indication that the wireless mobile device received the beacon signal.

16. One or more non-transitory, computer-readable storage media storing instructions recorded thereon, wherein the instructions, when executed by at least one data processor of a system of a telecommunications network, cause the system to:
detect a wireless mobile device in a indoor environment based on a signal generated by the wireless mobile device,
wherein the wireless mobile device is associated with a subscriber to a telecommunications network,
wherein the signal is generated in response to a beacon signal being received by the wireless mobile device, and
wherein the signal includes a unique identifier of the subscriber;
determine a micro-location of the wireless mobile device in the indoor environment, relative to a smart device in the indoor environment,
wherein the smart device is associated with an offer agreement for the indoor environment;
retrieve subscriber data based on the unique identifier of the subscriber,
wherein the subscriber data indicates activity data of the subscriber on the telecommunications network;
receive a personalized offer agreement as output from a large language model (LLM) based on input including the subscriber data,
wherein the LLM is trained based on subscriber activity data of subscribers on the telecommunications network; and
cause the wireless mobile device or the smart device to present the personalized offer agreement for the subscriber and the smart device.

17. The computer-readable storage media of claim 16, wherein the system is further caused to, prior to the wireless mobile device being detected:
cause a beacon device to transmit the beacon signal at a regular interval,
wherein the micro-location is determined based on the wireless mobile device receiving the beacon signal.

18. The computer-readable storage media of claim 16, wherein the system is further caused to, prior to the wireless mobile device being detected:
cause the smart device to transmit the beacon signal at a regular interval,
wherein the micro-location is determined based on the wireless mobile device receiving the beacon signal.

19. The computer-readable storage media of claim 16:
wherein the micro-location is determined based on a received signal strength indicator (RSSI) of the signal, and
wherein the signal is transmitted using a Bluetooth protocol or a Wi-Fi protocol.

20. The computer-readable storage media of claim 16, wherein to determine the micro-location of the wireless mobile device in the indoor environment comprises causing the system to:
estimate a distance to the wireless mobile device from the smart device based on an image of the wireless mobile device captured by a camera of the smart device,
wherein the estimate is based on a size of the wireless mobile device in the image,
wherein the wireless mobile device is determined to be proximate to the smart device when the estimate satisfies or exceeds a threshold distance.
